(19) United States
(12) Patent Application Publication
(10) Pub. No.: US 2026/0030852 A1
(43) Pub. Date: Jan. 29, 2026

(54) POWER VISION DATASET AUGMENTATION METHOD AND SYSTEM BASED ON PHYSICAL SYSTEM CHARACTERISTICS

(71) Applicants: STATE GRID SHANXI ELECTRIC POWER RESEARCH INSTITUTE, Taiyuan (CN); STATE GRID SHANXI ELECTRIC POWER COMPANY, Taiyuan (CN)

(72) Inventors: Na ZHANG, Taiyuan (CN); Fan HU, Taiyuan (CN); Gang YANG, Taiyuan (CN); Zeyuan MA, Taiyuan (CN); Hua YU, Taiyuan (CN); Jizhong LIANG, Taiyuan (CN); Jingjing FAN, Taiyuan (CN); Hui YUAN, Taiyuan (CN); Jingjin CAO, Taiyuan (CN); Jin ZHAO, Taiyuan (CN); Minjie CHAI, Taiyuan (CN); Changwen SUN, Taijuan (CN); Haiqi WANG, Taiyuan (CN); Guodong LI, Taiyuan (CN); Yang BAI, Taiyuan (CN); Siqing XU, Taiyuan (CN)

(21) Appl. No.: 18/995,633

(22) PCT Filed: Dec. 5, 2024
(86) PCT No.: PCT/CN2024/137028

§ 371 Date: Jan. 16, 2025

(30) Foreign Application Priority Data
Dec. 5, 2023 (CN) 202311655113.0

(51) Int. Cl. G06T 19/20; G06T 5/50; G06T 7/11; G06T 15/50; G06V 10/54; G06V 10/56; G06V 10/60; G06V 10/762

(52) U.S. Cl. CPC G06T 19/20; G06T 5/50; G06T 7/11; G06T 15/506; G06V 10/54; G06V 10/56; G06V 10/60; G06V 10/762; G06T 2207/20221; G06T 2219/2016

(57) ABSTRACT

A power vision dataset augmentation method includes acquiring an initial three-dimensional structure point cloud of a power device, preprocessing the initial three-dimensional structure point cloud to obtain a three-dimensional structure point cloud, and determining point clouds of power device vertices and edges based on the three-dimensional structure point cloud; partitioning point clouds of the non-significant vertices and edges in the three-dimensional structure point cloud and replacing partitions with geometric plane primitives to obtain a three-dimensional structure represented by the geometric plane primitives; determining light and shadow information of the power device based on a captured image; matching the three-dimensional structure with the captured image; determining a three-dimensional true-color structure of the power device based on the light and shadow information of the power device after the three-dimensional structure matches the captured image; and constructing a dataset based on the three-dimensional true-color structure and the captured image.

The application claims priority to Chinese Patent Application No. 202311655113.0 filed with the China National Intellectual Property Administration (CNIPA) on Dec. 5, 2023, the disclosure of which is incorporated herein by reference in its entirety.

### TECHNICAL FIELD

The application relates to the field of dataset augmentation technologies, for example, a power vision dataset augmentation method and system based on physical system characteristics.

### BACKGROUND

At present, the development of power grid digitalization and intelligent transformation has promoted the development and application of a large number of power visual identification models, including identification of visual data such as visible light data and infrared data and identification of device defect faults, environmental anomalies and risks, and particular device targets or components in visual data. For a performance test of an identification model in the general field, test and verification are generally performed based on a public large dataset (for example, ImageNet), and the test capability and performance of the model are estimated and evaluated based on the identification result. An identification model process in the professional field is also rapidly advancing, but data in the professional field is different from data in the general field in that a small number of public datasets are available, data is usually not easy to acquire or is acquired at an inflexible angle and in a nonuniform standard, there are problems such as the need to standardize a verification dataset before model verification, the test and verification of the model often face independence and effectiveness problems of the test dataset, and reflection of the model robustness test is not objective enough. The visual data generation method based on a mainstream generation model has the problem of not complying with physical system characteristics such as illumination and materials in practical application. However, a visual data generation method based on a physical engine has a relatively high requirement on a computing capability, and because parameter setting of the physical engine involves a dynamic process, continuous debugging and training are required, and use on the field or a terminal is limited, posing a relatively high requirement on the technical level of a frontline worker.

### SUMMARY

Therefore, the problem to be solved by the application is to overcome the problem that a subsequent model robustness test result is not objective enough due to the lack of a corresponding dataset as a support in a professional field in the related art.

To solve this problem, the application provides a power vision dataset augmentation method based on physical system characteristics. The method includes acquiring an initial three-dimensional structure point cloud of a power device, preprocessing the initial three-dimensional structure point cloud to obtain a three-dimensional structure point cloud, and determining point clouds of power device vertices and edges based on the three-dimensional structure point cloud: partitioning point clouds of the non-significant vertices and edges in the three-dimensional structure point cloud and replacing partitions with geometric plane primitives to obtain a three-dimensional structure represented by the geometric plane primitives, where the point clouds of the non-significant vertices and edges are point clouds with a feature degree lower than a preset percentage: acquiring a captured image of the power device and determining light and shadow information of the power device based on the captured image: matching the three-dimensional structure with the captured image by transforming the angle and the scale of the three-dimensional structure: determining a three-dimensional true-color structure of the power device based on the light and shadow information of the power device after the three-dimensional structure matches the captured image: and constructing a dataset based on the three-dimensional true-color structure and the captured image.

In an embodiment of the application, acquiring the initial three-dimensional structure point cloud of the power device, preprocessing the initial three-dimensional structure point cloud to obtain the three-dimensional structure point cloud, and determining the point clouds of the power device vertices and edges based on the three-dimensional structure point cloud includes acquiring the initial three-dimensional structure point cloud of the power device, performing point cloud registration and point cloud filtering on the initial three-dimensional structure point cloud to obtain the three-dimensional structure point cloud, performing a voxel gradient solution on the three-dimensional structure point cloud based on point cloud voxels, and calculating a gradient change rate maximum value to obtain coordinates of the power device vertices and edges in the three-dimensional structure point cloud: and for edge coordinates of the power device in the three-dimensional structure point cloud, segmenting a point cloud at a position of the edge coordinates based on a clustering algorithm to obtain several cluster subsets, detecting a curvature change and a normal direction change of a local space point set in the several cluster subsets, and calculating an edge representation of the three-dimensional structure point cloud based on an RANSAC algorithm.

In an embodiment of the application, partitioning the point clouds of the non-significant vertices and edges in the three-dimensional structure point cloud and replacing the partitions with the geometric plane primitives to obtain the three-dimensional structure represented by the geometric plane primitives includes perform partition on regions of the point clouds of the non-significant vertices and edges in the three-dimensional structure point cloud based on a clustering algorithm, where a partition equivalent diameter is less than 0.5 times a minimum length of a point cloud detection line: and replacing partitions with triangle plane primitives to obtain a three-dimensional structure represented by the triangle plane primitives, where the partitions are obtained from clustering.

In an embodiment of the application, acquiring the captured image of the power device and determining the light and shadow information of the power device based on the captured image includes acquiring the captured image of a power device and separating illumination information of the power device in the captured image based on a surface reflection method: setting different regions of the power device to have specular reflection or diffuse reflection based on material characteristics, where the specular reflection is generated by a smooth resin material of the power device, and the diffuse reflection is generated by a paint surface or a metal surface of the power device: and acquiring illumination information of the power device in a corresponding region based on an illumination model of the specular reflection or the diffuse reflection to obtain illumination-material key-value pairs: performing region segmentation on color information in the captured image based on a K-means algorithm, pairing and recording material information and the color information of the power device to form material-color key-value pairs, and setting regions of a same material but different colors as shadow-color key-value pairs: detecting texture information of the captured image through a Gabor filter and constructing texture-material key-value pairs based on material distribution of the power device: and constituting the light and shadow information of the power device by the illumination-material key-value pairs, the material-color key-value pairs, the shadow-color key-value pairs, and the texture-material key-value pairs.

In an embodiment of the application, matching the three-dimensional structure with the captured image by transforming the angle and the scale of the three-dimensional structure includes calculating a matching degree between corner and edge features in the captured image and the three-dimensional structure by transforming the angle and the scale of the three-dimensional structure, determining the angle and the scale of the three-dimensional structure at a minimum matching error by optimizing the matching error, regarding the captured image as a projection of the three-dimensional structure at the angle and the scale, and regarding illumination information, color information, and texture information of the captured image as two-dimensional image information of an orthogonal projection of the three-dimensional structure at the angle and the scale.

In an embodiment of the application, determining the three-dimensional true-color structure of the power device based on the light and shadow information of the power device after the three-dimensional structure matches the captured image includes determining illumination information, color information, and texture information of the three-dimensional structure at the angle and the scale by using inverse orthogonal projection and considering shadow projection mapping under depth information after the three-dimensional structure matches the captured image: and fitting and complementing illumination information, color information, and texture information of a rest of the three-dimensional structure under constraint of the geometric plane primitives based on the extracted illumination-material key-value pairs, material-color key-value pairs, shadow-color key-value pairs and texture-material key-value pairs to obtain the three-dimensional true-color structure with the illumination information, the color information, and the texture information.

In an embodiment of the application, constructing the dataset based on the three-dimensional true-color structure and the captured image includes orthogonally projecting the three-dimensional true-color structure at different angles and scales to obtain two-dimensional image data in any direction and size: determining an image set A of the power device with partially occlusion based on angle transformation: adjusting illumination to obtain an image set B under strong light and weak light: conducting angle transformation by a preset amplitude for a location of a specified component or defect of the power device to obtain an image set C of a target at different viewing angles: scaling up and down a specified target of the power device to obtain a local image set D and an image set E with a small proportion of target pixels: and combining the captured image, the image set A, the image set B, the image set C, the image set D, and the image set E into the dataset.

To solve this problem, the application provides a power vision dataset augmentation system based on physical system characteristics. The system includes an acquisition and determination module configured to acquire an initial three-dimensional structure point cloud of a power device, preprocess the initial three-dimensional structure point cloud to obtain a three-dimensional structure point cloud, and determine point clouds of power device vertices and edges based on the three-dimensional structure point cloud: a three-dimensional structure construction module configured to partition point clouds of the non-significant vertices and edges in the three-dimensional structure point cloud and replace partitions with geometric plane primitives to obtain a three-dimensional structure represented by the geometric plane primitives, where the point clouds of the non-significant vertices and edges are point clouds with a feature degree lower than a preset percentage: an acquisition and matching module configured to acquire a captured image of the power device and determine light and shadow information of the power device based on the captured image: and match the three-dimensional structure with the captured image by transforming the angle and the scale of the three-dimensional structure: a three-dimensional true-color structure construction module configured to determine a three-dimensional true-color structure of the power device based on the light and shadow information of the power device after the three-dimensional structure matches the captured image: and a dataset construction module configured to construct a dataset based on the three-dimensional true-color structure and the captured image.

In an embodiment of the application, the application provides an electronic device. The electronic device includes a memory, a processor, and a computer program stored in the memory and executable on the processor. The processor is configured to, when executing the computer program, perform steps of the preceding power vision dataset augmentation method based on physical system characteristics.

In an embodiment of the application, the application provides a computer-readable storage medium storing a computer program which, when executed by a processor, causes the processor to perform steps of the preceding power vision dataset augmentation method based on physical system characteristics.

Compared with the related art, the preceding solution of the application has the following advantages: The application constructs the image dataset based on the three-dimensional structure point cloud of the power device and the captured image of the power device. The image dataset can be used for robustness testing of a power vision identification model. The application implements flexible augmentation of a particular power scene image dataset, providing effective data support for robustness testing of a power vision identification model in a professional field (power field).

### BRIEF DESCRIPTION OF DRAWINGS

To make content of the application understood more clearly, the following describes the application in detail in conjunction with embodiments and drawings of the application.

FIG. 1 is a flowchart of a method according to the application.

### DETAILED DESCRIPTION

The application is described in detail in conjunction with embodiments and drawings so that those skilled in the art can better understand and implement the application, but the embodiments are not intended to limit the application.

### Embodiment One

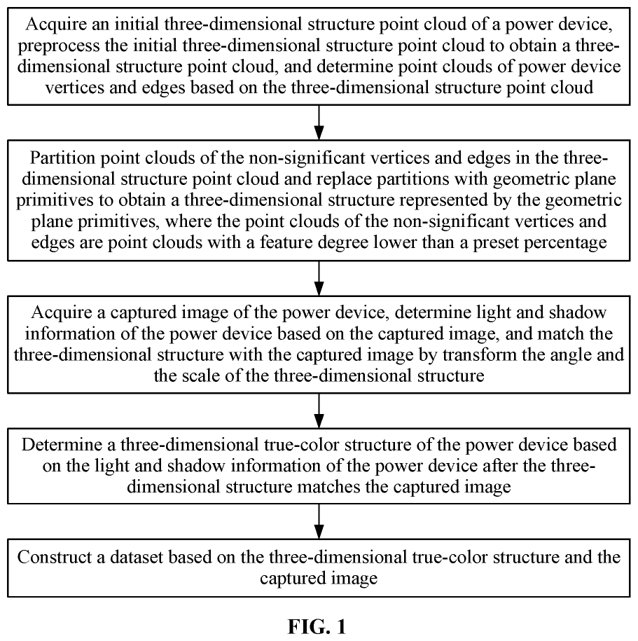

Referring to FIG. 1, the application relates to a power vision dataset augmentation method based on physical system characteristics. The method may be applied to a power vision identification model. The method includes the following:

In step S1, an initial three-dimensional structure point cloud of a power device is acquired, the initial three-dimensional structure point cloud is preprocessed to obtain a three-dimensional structure point cloud, and point clouds of power device vertices and edges are determined based on the three-dimensional structure point cloud.

In step S2, point clouds of the non-significant vertices and edges in the three-dimensional structure point cloud are partitioned, and partitions are replaced with geometric plane primitives to obtain a three-dimensional structure represented by the geometric plane primitives, where the point clouds of the non-significant vertices and edges are point clouds with a feature degree lower than a preset percentage.

In step S3, a captured image of the power device is acquired, and light and shadow information of the power device is determined based on the captured image: and the three-dimensional structure is matched with the captured image by transforming the angle and the scale of the three-dimensional structure.

In step S4, a three-dimensional true-color structure of the power device is determined based on the light and shadow information of the power device after the three-dimensional structure matches the captured image.

In step S5, a dataset is constructed based on the three-dimensional true-color structure and the captured image.

The dataset augmentation method of this embodiment can achieve flexible augmentation of a particular power scene image dataset.

The following describes this embodiment in detail:

The method of this embodiment includes six parts: (1) acquisition of the three-dimensional structure point cloud, (2) primitive extraction of the three-dimensional structure point cloud, (3) extraction of light and shadow information of the captured image, (4) transformation of different angles and scales of a three-dimensional structure, (5) construction of the three-dimensional true-color structure through light and shadow information mapping, and (6) acquisition of the dataset.

### (1) Acquisition of the Three-Dimensional Structure Point Cloud

Acquisition of the three-dimensional structure of the power device is to obtain the initial three-dimensional structure point cloud of the power device based on laser radar or structured light, including static information such as coordinates and shape of the power device. The initial three-dimensional structure point cloud is subjected to point cloud registration and point cloud filtering processing to obtain a three-dimensional structure point cloud with high precision. Voxel gradient solving is performed based on point cloud voxels. The gradient change rate maximum value is calculated. In this manner, coordinate attributes of vertices and edges (that is, boundary line segments) in the three-dimensional structure point cloud are obtained. Thus, it is considered in this embodiment that the vertex representation of the three-dimensional structure point cloud is obtained. The point clouds at the edge coordinate positions are segmented based on the clustering algorithm to obtain several cluster subsets. The normal direction and the curvature of the local space point set in the several cluster subsets are detected. The edge representation of the three-dimensional structure point cloud is obtained based on the detected curvature change and normal direction change in combination with the point cloud line segment detection algorithm RANSAC.

### (2) Primitive Extraction of the Three-Dimensional Structure Point Cloud

For regions of non-significant vertices and edges in the three-dimensional structure point cloud (point cloud whose feature degree is lower than a preset percentage obtained based on the clustering algorithm of part (1)), the point cloud is partitioned by using the clustering algorithm to obtain partitions by replacing partitions obtained by using the clustering algorithm with geometric plane primitives (triangle plane primitives are used in this embodiment). The sizes of the triangle plane primitives are processed in this embodiment so that the triangles are smaller as much as possible so that the subsequent three-dimensional structure is sufficiently smooth. The three points of the triangle plane primitive satisfy that there is no gap between structures. In this manner, the three-dimensional structure represented by the triangle plane primitives is obtained.

Further, the three-dimensional structure may be transformed at different angles and different scales based on rotation and translation. The vertices in the three-dimensional structure are subjected to orthogonal projection transformation at a certain angle to obtain two-dimensional projection coordinates of the vertices at the angle. The triangle plane primitives at the intersection with the normal plane of the projection plane are decomposed into smaller triangles based on the intersection line, facilitating projection processing.

### (3) Extraction of Light and Shadow Information of the Captured Image

The captured image of the power device, especially image data actually acquired in the presence of defects in the power device generally has no reproducibility. In this embodiment, the illumination information of the power device in the captured image is separated by using the surface reflection method. The material of each part of the power device is known by default in this embodiment. Different regions are set to have specular reflection (smooth resin material) and diffuse reflection (paint and metal surface) based on the material characteristics. The illumination information of the device in the corresponding region is obtained based on illumination models with the two reflection modes to obtain the illumination-material key-value pairs. In this embodiment, the color information in the captured image is subjected to region segmentation based on the K-means algorithm. The device material information and the color information of the device are matched and recorded to form material-color key-value pairs. Partitions of the same material but different colors are set as shadow-color key-value pairs. In this embodiment, the texture information of the captured image is detected by using the Gabor filter. The texture-material key-value pairs are constructed by comparing the material distribution of the device.

The illumination-material key-value pairs, the material-color key-value pairs, the shadow-color key-value pairs, and the texture-material key-value pairs constitute light and shadow information of the power device.

### (4) Transformation of Different Angles and Scales of the Three-Dimensional Structure

By transforming the angle and scale of the three-dimensional structure, the matching degree between the corner and edge features of the captured image device and the three-dimensional structure is calculated, and by adjusting the matching error, the angle and scale corresponding to the three-dimensional structure are obtained at the minimum error, at this time, the captured image can be regarded as the projection of the three-dimensional structure at this angle and scale, and the information such as the illumination, color, and texture of the image target (i.e., the power device) extracted from the captured image is the two-dimensional image information of the three-dimensional structure after orthogonal projection at this angle and scale.

### (5) Construction of the Three-Dimensional True-Color Structure Through Light and Shadow Information Mapping

Illumination information, color information, and texture information of the three-dimensional structure at the angle and the scale is determined by using inverse orthogonal projection and considering shadow projection mapping under depth information after the three-dimensional structure matches the captured image: and illumination information, color information, and texture information of a rest of the three-dimensional structure are fitted and complemented under constraint of the geometric plane primitives based on the extracted illumination-material key-value pairs, material-color key-value pairs, shadow-color key-value pairs and texture-material key-value pairs to obtain the three-dimensional true-color structure with the illumination information, the color information, and the texture information.

### (6) Acquisition of the Dataset

The three-dimensional true-color structure is controlled at different angles and scales. Orthogonal projection is performed at different angles and scales to obtain two-dimensional image data in any direction and size.

An image set A of the target (that is, the power device) with partially occlusion is determined based on angle transformation.

An image set B under strong light and weak light is obtained by adjusting illumination.

Angle transformation is conducted by a small amplitude for a location of a specified component or defect of the power device to obtain an image set C of the target at different viewing angles.

A specified target is scaled up and down to obtain a local image set D and an image set E with a small proportion of target pixels.

A combined transformation or other transformations are performed based on requirements to obtain an image set Pi.

The captured image, the image set A, the image set B, the image set C, the image set D, the image set E, and the image set Pi are combined into an augmented dataset suitable for robustness testing of the power vision identification model. The robustness testing of the dataset is derived from augmentation of data by flexible transformation of the three-dimensional structure. The image sets are subjected to batch classification processing based on test requirements. Verification and detection of the power vision algorithm model are carried out in the form of batch data.

Moreover, the augmented dataset can also be used to improve the capability of the power vision algorithm model. The effective collection of the captured image data is fed back based on the improvement in the identification capability.

### Embodiment Two

This embodiment provides a power vision dataset augmentation system based on physical system characteristics. The system includes an acquisition and determination module configured to acquire an initial three-dimensional structure point cloud of a power device, preprocess the initial three-dimensional structure point cloud to obtain a three-dimensional structure point cloud, and determine point clouds of power device vertices and edges based on the three-dimensional structure point cloud: a three-dimensional structure construction module configured to partition point clouds of the non-significant vertices and edges in the three-dimensional structure point cloud and replace partitions with geometric plane primitives to obtain a three-dimensional structure represented by the geometric plane primitives, where the point clouds of the non-significant vertices and edges are point clouds with a feature degree lower than a preset percentage: an acquisition and matching module configured to acquire a captured image of the power device, and determine light and shadow information of the power device based on the captured image, and match the three-dimensional structure with the captured image by transforming the angle and the scale of the three-dimensional structure: a three-dimensional true-color structure construction module configured to determine a three-dimensional true-color structure of the power device based on the light and shadow information of the power device after the three-dimensional structure matches the captured image: and a dataset construction module configured to construct a dataset based on the three-dimensional true-color structure and the captured image.

### Embodiment Three

This embodiment provides an electronic device. The electronic device includes a memory, a processor, and a computer program stored in the memory and executable on the processor. The processor is configured to, when executing the computer program, perform steps of the power vision dataset augmentation method based on physical system characteristics according to embodiment one.

### Embodiment Four

This embodiment provides a computer-readable storage medium storing a computer program which, when executed by a processor, causes the processor to perform steps of the power vision dataset augmentation method based on physical system characteristics according to embodiment one.

It is to be understood by those skilled in the art that embodiments of the application may be provided as methods, systems, or computer program products. Therefore, the application may take the form of an entirely hardware embodiment, an entirely software embodiment or an embodiment combining software and hardware aspects. Moreover, the application may take the form of a computer program product implemented on one or more computer-usable storage media (including, but not limited to, a disk memory, a compact disc read-only memory (CD-ROM), and an optical memory) that includes computer-usable program codes. Solutions in embodiments of the application may be implemented using various computer languages such as the object-oriented programming language Java and the interpreted scripting language JavaScript.

The application is described with reference to flowcharts and/or block diagrams of methods, devices (systems), and computer program products according to embodiments of the application. It is to be understood that each flow and/or block in the flowcharts and/or block diagrams and a combination of flows and/or blocks in the flowcharts and/or block diagrams may be implemented by computer program instructions. These computer program instructions may be provided to a processor of a general-purpose computer, a special-purpose computer, an embedded processor, or another programmable data processing device to produce a machine so that instructions executed by the processor of the computer or another programmable data processing device create an apparatus for implementing functions specified in one or more flows in the flowcharts and/or in one or more blocks in the block diagrams.

These computer program instructions may also be stored in a computer-readable memory which can direct a computer or another programmable data processing device to operate in a particular manner so that instructions stored in the computer-readable memory create an article of manufacture including an instructing apparatus for implementing functions specified in one or more flows in the flowcharts and/or in one or more blocks in the block diagrams.

These computer program instructions may also be loaded onto a computer or another programmable data processing device so that a series of operation steps are performed on the computer or another programmable device to produce processing implemented by the computer. Therefore, instructions executed on the computer or another programmable device provide steps for implementing functions specified in one or more flows in the flowcharts and/or in one or more blocks in the block diagrams.

1. A power vision dataset augmentation method based on physical system characteristics, comprising:
acquiring an initial three-dimensional structure point cloud of a power device, preprocessing the initial three-dimensional structure point cloud to obtain a three-dimensional structure point cloud, and determining point clouds of power device vertices and edges based on the three-dimensional structure point cloud;
partitioning point clouds of non-significant vertices and edges in the three-dimensional structure point cloud and replacing partitions with geometric plane primitives to obtain a three-dimensional structure represented by the geometric plane primitives, wherein the point clouds of the non-significant vertices and edges are point clouds with a feature degree lower than a preset percentage;
acquiring a captured image of the power device and determining light and shadow information of the power device based on the captured image;
matching the three-dimensional structure with the captured image by transforming an angle and a scale of the three-dimensional structure;
determining a three-dimensional true-color structure of the power device based on the light and shadow information of the power device after the three-dimensional structure matches the captured image; and
constructing a dataset based on the three-dimensional true-color structure and the captured image.

2. The power vision dataset augmentation method based on physical system characteristics according to claim 1, wherein acquiring the initial three-dimensional structure point cloud of the power device, preprocessing the initial three-dimensional structure point cloud to obtain the three-dimensional structure point cloud, and determining the point clouds of the power device vertices and edges based on the three-dimensional structure point cloud comprises:
acquiring the initial three-dimensional structure point cloud of the power device, performing point cloud registration and point cloud filtering on the initial three-dimensional structure point cloud to obtain the three-dimensional structure point cloud, performing a voxel gradient solution on the three-dimensional structure point cloud based on point cloud voxels, and calculating a gradient change rate maximum value to obtain coordinates of the power device vertices and edges in the three-dimensional structure point cloud; and
for edge coordinates of the power device in the three-dimensional structure point cloud, segmenting a point cloud at a position of the edge coordinates based on a clustering algorithm to obtain several cluster subsets, detecting a curvature change and a normal direction change of a local space point set in the several cluster subsets, and calculating an edge representation of the three-dimensional structure point cloud based on an RANSAC algorithm.

3. The power vision dataset augmentation method based on physical system characteristics according to claim 1, wherein partitioning the point clouds of the non-significant vertices and edges in the three-dimensional structure point cloud and replacing the partitions with the geometric plane primitives to obtain the three-dimensional structure represented by the geometric plane primitives comprises:
performing partition on regions of the point clouds of the non-significant vertices and edges in the three-dimensional structure point cloud based on a clustering algorithm, wherein a partition equivalent diameter is less than 0.5 times a minimum length of a point cloud detection line; and replacing partitions obtained by the clustering algorithm with triangle plane primitives to obtain a three-dimensional structure represented by the triangle plane primitives.

4. The power vision dataset augmentation method based on physical system characteristics according to claim 1, wherein acquiring the captured image of the power device and determining the light and shadow information of the power device based on the captured image comprises:
acquiring the captured image of the power device and separating illumination information of the power device in the captured image based on a surface reflection method: setting different regions of the power device to have specular reflection or diffuse reflection based on material characteristics, wherein the specular reflection is generated by a smooth resin material of the power device, and the diffuse reflection is generated by a paint surface or a metal surface of the power device; and acquiring illumination information of the power device in a corresponding region based on an illumination model of the specular reflection or the diffuse reflection to obtain illumination-material key-value pairs;
performing region segmentation on color information in the captured image based on a K-means algorithm, pairing and recording material information and the color information of the power device to form material-color key-value pairs, and setting regions of a same material but different colors as shadow-color key-value pairs;
detecting texture information of the captured image through a Gabor filter and constructing texture-material key-value pairs based on material distribution of the power device; and
constituting the light and shadow information of the power device by the illumination-material key-value pairs, the material-color key-value pairs, the shadow-color key-value pairs, and the texture-material key-value pairs.

5. The power vision dataset augmentation method based on physical system characteristics according to claim 4, wherein matching the three-dimensional structure with the captured image by transforming the angle and the scale of the three-dimensional structure comprises: calculating a matching degree between corner and edge features in the captured image and the three-dimensional structure by transforming the angle and the scale of the three-dimensional structure, determining the angle and the scale of the three-dimensional structure at a minimum matching error by optimizing the matching error, regarding the captured image as a projection of the three-dimensional structure at the angle and the scale, and regarding illumination information, color information, and texture information of the captured image as two-dimensional image information of an orthogonal projection of the three-dimensional structure at the angle and the scale.

6. The power vision dataset augmentation method based on physical system characteristics according to claim 5, wherein determining the three-dimensional true-color structure of the power device based on the light and shadow information of the power device after the three-dimensional structure matches the captured image comprises:
determining illumination information, color information, and texture information of the three-dimensional structure at the angle and the scale by using inverse orthogonal projection and considering shadow projection mapping under depth information after the three-dimensional structure matches the captured image; and
fitting and complementing illumination information, color information, and texture information of a rest of the three-dimensional structure under constraint of the geometric plane primitives based on the extracted illumination-material key-value pairs, material-color key-value pairs, shadow-color key-value pairs and texture-material key-value pairs to obtain the three-dimensional true-color structure with the illumination information, the color information, and the texture information.

7. The power vision dataset augmentation method based on physical system characteristics according to claim 1, wherein constructing the dataset based on the three-dimensional true-color structure and the captured image comprises: orthogonally projecting the three-dimensional true-color structure at different angles and scales to obtain two-dimensional image data in any direction and size;
determining an image set A of the power device with partially occlusion based on angle transformation;
adjusting illumination to obtain an image set B under strong light and weak light;
conducting angle transformation by a preset amplitude for a location of a specified component or defect of the power device to obtain an image set C of a target at different viewing angles;
scaling up and down a specified target of the power device to obtain a local image set D and an image set E with a small proportion of target pixels; and
combining the captured image, the image set A, the image set B, the image set C, the image set D, and the image set E into the dataset.

8. (canceled)

9. An electronic device, comprising a memory, a processor, and a computer program stored in the memory and executable on the processor, wherein the processor is configured to, when executing the computer program, perform the following steps:
acquiring an initial three-dimensional structure point cloud of a power device, preprocessing the initial three-dimensional structure point cloud to obtain a three-dimensional structure point cloud, and determining point clouds of power device vertices and edges based on the three-dimensional structure point cloud;
partitioning point clouds of non-significant vertices and edges in the three-dimensional structure point cloud and replacing partitions with geometric plane primitives to obtain a three-dimensional structure represented by the geometric plane primitives, wherein the point clouds of the non-significant vertices and edges are point clouds with a feature degree lower than a preset percentage;
acquiring a captured image of the power device and determining light and shadow information of the power device based on the captured image;
matching the three-dimensional structure with the captured image by transforming an angle and a scale of the three-dimensional structure;
determining a three-dimensional true-color structure of the power device based on the light and shadow information of the power device after the three-dimensional structure matches the captured image; and
constructing a dataset based on the three-dimensional true-color structure and the captured image.

10. A non-transitory computer-readable storage medium storing a computer program which, when executed by a processor, causes the processor to perform the following steps:
acquiring an initial three-dimensional structure point cloud of a power device, preprocessing the initial three-dimensional structure point cloud to obtain a three-dimensional structure point cloud, and determining point clouds of power device vertices and edges based on the three-dimensional structure point cloud;
partitioning point clouds of non-significant vertices and edges in the three-dimensional structure point cloud and replacing partitions with geometric plane primitives to obtain a three-dimensional structure represented by the geometric plane primitives, wherein the point clouds of the non-significant vertices and edges are point clouds with a feature degree lower than a preset percentage;
acquiring a captured image of the power device and determining light and shadow information of the power device based on the captured image;
matching the three-dimensional structure with the captured image by transforming an angle and a scale of the three-dimensional structure;
determining a three-dimensional true-color structure of the power device based on the light and shadow information of the power device after the three-dimensional structure matches the captured image; and
constructing a dataset based on the three-dimensional true-color structure and the captured image.

11. The power vision dataset augmentation method based on physical system characteristics according to claim 2, wherein constructing the dataset based on the three-dimensional true-color structure and the captured image comprises:
orthogonally projecting the three-dimensional true-color structure at different angles and scales to obtain two-dimensional image data in any direction and size;
determining an image set A of the power device with partially occlusion based on angle transformation;
adjusting illumination to obtain an image set B under strong light and weak light;
conducting angle transformation by a preset amplitude for a location of a specified component or defect of the power device to obtain an image set C of a target at different viewing angles;
scaling up and down a specified target of the power device to obtain a local image set D and an image set E with a small proportion of target pixels; and
combining the captured image, the image set A, the image set B, the image set C, the image set D, and the image set E into the dataset.

12. The power vision dataset augmentation method based on physical system characteristics according to claim 3, wherein constructing the dataset based on the three-dimensional true-color structure and the captured image comprises:
orthogonally projecting the three-dimensional true-color structure at different angles and scales to obtain two-dimensional image data in any direction and size;
determining an image set A of the power device with partially occlusion based on angle transformation;
adjusting illumination to obtain an image set B under strong light and weak light;
conducting angle transformation by a preset amplitude for a location of a specified component or defect of the power device to obtain an image set C of a target at different viewing angles;
scaling up and down a specified target of the power device to obtain a local image set D and an image set E with a small proportion of target pixels; and
combining the captured image, the image set A, the image set B, the image set C, the image set D, and the image set E into the dataset.

13. The power vision dataset augmentation method based on physical system characteristics according to claim 4, wherein constructing the dataset based on the three-dimensional true-color structure and the captured image comprises:
orthogonally projecting the three-dimensional true-color structure at different angles and scales to obtain two-dimensional image data in any direction and size;
determining an image set A of the power device with partially occlusion based on angle transformation;
adjusting illumination to obtain an image set B under strong light and weak light;
conducting angle transformation by a preset amplitude for a location of a specified component or defect of the power device to obtain an image set C of a target at different viewing angles;
scaling up and down a specified target of the power device to obtain a local image set D and an image set E with a small proportion of target pixels; and
combining the captured image, the image set A, the image set B, the image set C, the image set D, and the image set E into the dataset.

14. The power vision dataset augmentation method based on physical system characteristics according to claim 5, wherein constructing the dataset based on the three-dimensional true-color structure and the captured image comprises:
orthogonally projecting the three-dimensional true-color structure at different angles and scales to obtain two-dimensional image data in any direction and size;
determining an image set A of the power device with partially occlusion based on angle transformation;
adjusting illumination to obtain an image set B under strong light and weak light;
conducting angle transformation by a preset amplitude for a location of a specified component or defect of the power device to obtain an image set C of a target at different viewing angles;
scaling up and down a specified target of the power device to obtain a local image set D and an image set E with a small proportion of target pixels; and
combining the captured image, the image set A, the image set B, the image set C, the image set D, and the image set E into the dataset.

15. The power vision dataset augmentation method based on physical system characteristics according to claim 6, wherein constructing the dataset based on the three-dimensional true-color structure and the captured image comprises:
orthogonally projecting the three-dimensional true-color structure at different angles and scales to obtain two-dimensional image data in any direction and size;
determining an image set A of the power device with partially occlusion based on angle transformation;
adjusting illumination to obtain an image set B under strong light and weak light; conducting angle transformation by a preset amplitude for a location of a specified component or defect of the power device to obtain an image set C of a target at different viewing angles;
scaling up and down a specified target of the power device to obtain a local image set D and an image set E with a small proportion of target pixels; and
combining the captured image, the image set A, the image set B, the image set C, the image set D, and the image set E into the dataset.

16. The device according to claim 9, wherein acquiring the initial three-dimensional structure point cloud of the power device, preprocessing the initial three-dimensional structure point cloud to obtain the three-dimensional structure point cloud, and determining the point clouds of the power device vertices and edges based on the three-dimensional structure point cloud comprises:
acquiring the initial three-dimensional structure point cloud of the power device, performing point cloud registration and point cloud filtering on the initial three-dimensional structure point cloud to obtain the three-dimensional structure point cloud, performing a voxel gradient solution on the three-dimensional structure point cloud based on point cloud voxels, and calculating a gradient change rate maximum value to obtain coordinates of the power device vertices and edges in the three-dimensional structure point cloud; and
for edge coordinates of the power device in the three-dimensional structure point cloud, segmenting a point cloud at a position of the edge coordinates based on a clustering algorithm to obtain several cluster subsets, detecting a curvature change and a normal direction change of a local space point set in the several cluster subsets, and calculating an edge representation of the three-dimensional structure point cloud based on an RANSAC algorithm.

17. The device according to claim 9, wherein partitioning the point clouds of the non-significant vertices and edges in the three-dimensional structure point cloud and replacing the partitions with the geometric plane primitives to obtain the three-dimensional structure represented by the geometric plane primitives comprises:
performing partition on regions of the point clouds of the non-significant vertices and edges in the three-dimensional structure point cloud based on a clustering algorithm, wherein a partition equivalent diameter is less than 0.5 times a minimum length of a point cloud detection line; and replacing partitions obtained by the clustering algorithm with triangle plane primitives to obtain a three-dimensional structure represented by the triangle plane primitives.

18. The device according to claim 9, wherein acquiring the captured image of the power device and determining the light and shadow information of the power device based on the captured image comprises:
acquiring the captured image of the power device and separating illumination information of the power device in the captured image based on a surface reflection method: setting different regions of the power device to have specular reflection or diffuse reflection based on material characteristics, wherein the specular reflection is generated by a smooth resin material of the power device, and the diffuse reflection is generated by a paint surface or a metal surface of the power device; and acquiring illumination information of the power device in a corresponding region based on an illumination model of the specular reflection or the diffuse reflection to obtain illumination-material key-value pairs;
performing region segmentation on color information in the captured image based on a K-means algorithm, pairing and recording material information and the color information of the power device to form material-color key-value pairs, and setting regions of a same material but different colors as shadow-color key-value pairs;
detecting texture information of the captured image through a Gabor filter and constructing texture-material key-value pairs based on material distribution of the power device; and
constituting the light and shadow information of the power device by the illumination-material key-value pairs, the material-color key-value pairs, the shadow-color key-value pairs, and the texture-material key-value pairs.

19. The device according to claim 18, wherein matching the three-dimensional structure with the captured image by transforming the angle and the scale of the three-dimensional structure comprises:
calculating a matching degree between corner and edge features in the captured image and the three-dimensional structure by transforming the angle and the scale of the three-dimensional structure, determining the angle and the scale of the three-dimensional structure at a minimum matching error by optimizing the matching error, regarding the captured image as a projection of the three-dimensional structure at the angle and the scale, and regarding illumination information, color information, and texture information of the captured image as two-dimensional image information of an orthogonal projection of the three-dimensional structure at the angle and the scale.

20. The device according to claim 19, wherein determining the three-dimensional true-color structure of the power device based on the light and shadow information of the power device after the three-dimensional structure matches the captured image comprises:
determining illumination information, color information, and texture information of the three-dimensional structure at the angle and the scale by using inverse orthogonal projection and considering shadow projection mapping under depth information after the three-dimensional structure matches the captured image; and
fitting and complementing illumination information, color information, and texture information of a rest of the three-dimensional structure under constraint of the geometric plane primitives based on the extracted illumination-material key-value pairs, material-color key-value pairs, shadow-color key-value pairs and texture-material key-value pairs to obtain the three-dimensional true-color structure with the illumination information, the color information, and the texture information.

21. The device according to claim 9, wherein constructing the dataset based on the three-dimensional true-color structure and the captured image comprises:
orthogonally projecting the three-dimensional true-color structure at different angles and scales to obtain two-dimensional image data in any direction and size;
determining an image set A of the power device with partially occlusion based on angle transformation;
adjusting illumination to obtain an image set B under strong light and weak light;
conducting angle transformation by a preset amplitude for a location of a specified component or defect of the power device to obtain an image set C of a target at different viewing angles;
scaling up and down a specified target of the power device to obtain a local image set D and an image set E with a small proportion of target pixels; and
combining the captured image, the image set A, the image set B, the image set C, the image set D, and the image set E into the dataset.
